(19) United States
(12) Patent Application Publication
(10) Pub. No.: US 2021/0356953 A1
(43) Pub. Date: Nov. 18, 2021

(54) DEVIATION DETECTION FOR UNCREWED VEHICLE NAVIGATION PATHS

(71) Applicant: AT&T Intellectual Property I, L.P., Atlanta, GA (US)

(72) Inventors: Eric Zavesky, Austin, TX (US); Jean-Francois Paiement, Sausalito, CA (US); Tan Xu, Bridgewater, NJ (US)

(21) Appl. No.: 16/876,242

(22) Filed: May 18, 2020

(51) Int. Cl. G05D 1/00; G06K 9/00; G01C 21/34; G01C 21/36

(52) U.S. Cl. CPC G05D 1/0011; G06K 9/00671; G01C 21/3602; G01C 21/3415; G05D 1/0055

(57) ABSTRACT

A processing system including at least one processor may determine a navigation path for an uncrewed vehicle, obtain, from the uncrewed vehicle, location information of the uncrewed vehicle, and obtain visual information from one or more cameras of one or more devices along the navigation path, in response to determining the navigation path for the uncrewed vehicle. The processing system may then determine a deviation from an expected condition along the navigation path based upon the visual information from the one or more devices along the navigation path and transmit a notification of the deviation from the expected condition.

The present disclosure relates generally to unscrewed vehicle operations, and more particularly to methods, computer-readable media, and apparatuses for determining a deviation from an expected condition along a navigation path of an uncrewed vehicle based upon visual information from one or more devices along the navigation path.

### BRIEF DESCRIPTION OF THE DRAWINGS

The teaching of the present disclosure can be readily understood by considering the following detailed description in conjunction with the accompanying drawings, in which:

FIG. 1 illustrates an example system related to the present disclosure;

FIG. 2 illustrates examples of detecting a deviation from an expected weather condition, and detecting a deviation from an expected condition of an obstruction, in accordance with the present disclosure;

FIG. 3 illustrates a flowchart of an example method for determining a deviation from an expected condition along a navigation path of an uncrewed vehicle based upon visual information from one or more devices along the navigation path, in accordance with the present disclosure; and

FIG. 4 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

In one example, the present disclosure discloses a method, computer-readable medium, and apparatus for determining a deviation from an expected condition along a navigation path of an uncrewed vehicle based upon visual information from one or more devices along the navigation path. For instance, in one example, a processing system including at least one processor may determine a navigation path for an uncrewed vehicle, obtain, from the uncrewed vehicle, location information of the uncrewed vehicle, and obtain visual information from one or more cameras of one or more devices along the navigation path, in response to determining the navigation path for the uncrewed vehicle. The processing system may then determine a deviation from an expected condition along the navigation path based upon the visual information from the one or more devices along the navigation path and transmit a notification of the deviation from the expected condition.

The present disclosure broadly discloses methods, computer-readable media, and apparatuses for determining a deviation from an expected condition along a navigation path of an uncrewed vehicle based upon visual information from one or more devices along the navigation path. In particular, examples of the present disclosure provide a system that assesses and manages safety conditions for uncrewed vehicles (e.g., “unmanned” (or also referred to as devoid of an onboard operator of the vehicle) aerial vehicles (UAVs), submersibles, surface travelling vehicles, etc.). In accordance with the present disclosure, an uncrewed vehicle may be remotely controlled by a human or autonomous system, or may be self-operating or partially self-operating (e.g., a combination of on-vehicle and remote computing resources). In one embodiment, such a vehicle in self-operating/autonomous operation mode may still have a human “non-operator” passenger.

New deconfliction (crash avoidance and safety) systems such as for UAVs, are rapidly coming into place as government and regulatory entities debate frameworks for managing this developing area. However, the way to qualify a site for safety may be ill-defined and often relies on governmental approval and inspection. In accordance with the present disclosure, cameras and sensors (either user held or fixed) can collect data (possibly with guidance) to determine attributes like visibility, wind pattern, safety ranges, etc., such that within minutes (instead of hours or days) a new zone can be approved or reprioritized. Examples of the present disclosure may provide instantaneous, local updates for uncrewed vehicle safety, and may combine sensor data with distributed computation to validate local conditions. In addition, examples of the present disclosure may complement regulation and coordination of uncrewed vehicles, including detection and validation of conditions, conveyance of restrictions (sensor and location), and coordination for multiple actors. In one example, the present disclosure also provides intelligent, automated distillation of risk assessment, and may provide a display for user with risk scores of locations for remote-operated navigation.

In one example, the present disclosure may utilize cameras and other sensors for instantaneous/local updates, supplement existing environment sensors (if any) with consumer level “on-the-ground” visual insights. In one example, the present disclosure may provide in-task continuous updates, such as providing an estimation of safety under different conditions (e.g., speed, size, maximum acceleration, etc.) that can be maintained as probabilistic ranges for real-time operation. Notably, the present disclosure utilizes crowdsourcing from fixed and mobile devices in an area to provide situational awareness, which may comprise automated quality-scored sensor readings and interpretations, and which may be more accurate than human-based assessments (which may be biased and subjective). In one example, safety predictions for navigation paths may be coordinated among autonomous and/or uncrewed vehicles and may be predicted against similar historical situations.

Crowdsourcing from fixed and mobile devices in an area may include providing interactive guidance for where to point a camera for more information (e.g., mountains to the north are usually snowdrift, please direct camera to the north to validate), obtaining visual information and/or sound measurements for wind conditions, obtaining visual information from difference perspectives for size estimation and clearance estimation for buildings or other obstructions perspectives (e.g., moving video for photogrammetry, visual odometry techniques, simultaneous localization and mapping (SLAM) techniques, or the like). In addition, in one example, the present disclosure may include an option to enable a regulator to seize control of a fixed or mobile device (e.g., with consent from the owner of the device) to facilitate visual inspection.

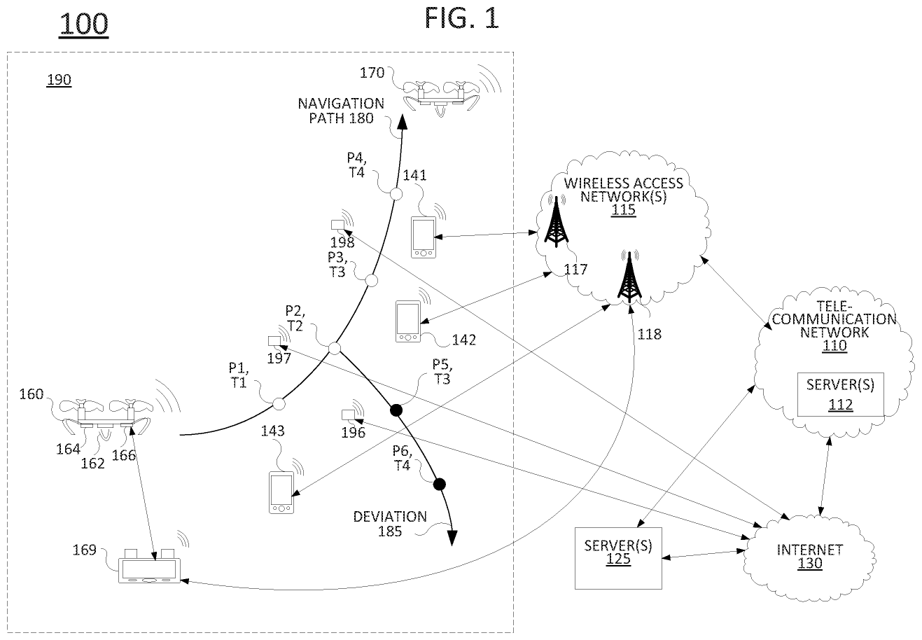

In one example, historical regions of risk are conveyed to uncrewed vehicles and/or their remote operators, such as warnings of areas having high wind gusts during certain times of day. In addition, additional observations (e.g., pictures) of known potential hazard areas may be obtained to provide up-to-date accuracy. In one example, navigation paths may be approved for uncrewed vehicles, with secondary permissions obtained from location owners. In addition, in one example, additional component restrictions (e.g., no photography or audio) or operational restrictions (e.g., no motor speed faster than 10,000 rotations per minute or louder than 70 dB) for a navigation path may be conveyed to an uncrewed vehicle and/or a remote operator. These and other aspects of the present disclosure are discussed in greater detail below in connection with the examples of FIGS. 1-4.

To aid in understanding the present disclosure, FIG. 1 illustrates an example system 100, related to the present disclosure. As shown in FIG. 1, the system 100 connects mobile devices 141-143, server(s) 112, server(s) 125, uncrewed aerial vehicles (UAVs 160 and 170), and camera units 196-198 (e.g., comprising fixed-location cameras, as well as computing and communication resources) with one another and with various other devices via a core network, e.g., a telecommunication network 110, a wireless access network 115 (e.g., a cellular network), and Internet 130.

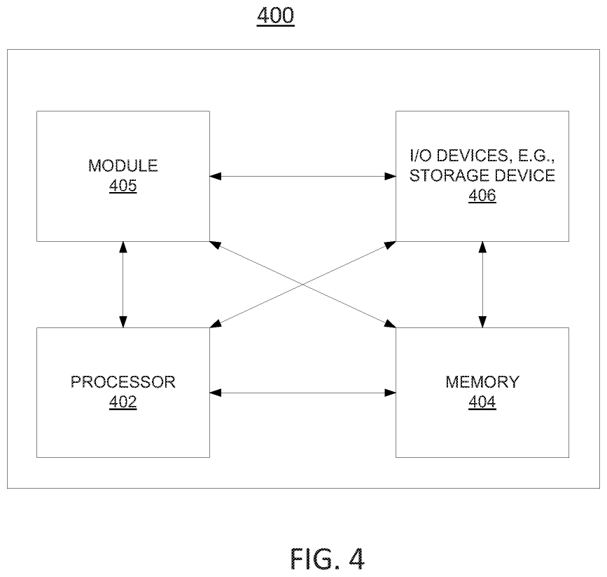

In one example, the server(s) 125 may each comprise a computing device or processing system, such as computing system 400 depicted in FIG. 4, and may be configured to provide one or more functions in connection with examples of the present disclosure for determining a deviation from an expected condition along a navigation path of an uncrewed vehicle based upon visual information from one or more devices along the navigation path. For example, server(s) 125 may be configured to perform one or more steps, functions, or operations in connection with the example method 300 described below. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 4 and discussed below) or multiple computing devices collectively configured to perform various steps, functions, and/or operations in accordance with the present disclosure.

In one example, server(s) 125 may receive and store location information and visual information from camera units 196-198, e.g., via connections over the Internet 130. In one example, server(s) 125 may also receive and store location information and visual information from mobile devices 141-143 and UAVs 160 and 170, e.g., via wireless access network(s) 115, telecommunication network 110, and/or internet 130. For instance, the server(s) 125 may include server(s) of an uncrewed vehicle monitoring service, in accordance with the present disclosure.

In one example, the system 100 includes a telecommunication network 110. In one example, telecommunication network 110 may comprise a core network, a backbone network or transport network, such as an Internet Protocol (IP)/multi-protocol label switching (MPLS) network, where label switched routes (LSRs) can be assigned for routing Transmission Control Protocol (TCP)/IP packets, User Datagram Protocol (UDP)/IP packets, and other types of protocol data units (PDUs), and so forth. It should be noted that an IP network is broadly defined as a network that uses Internet Protocol to exchange data packets. However, it will be appreciated that the present disclosure is equally applicable to other types of data units and transport protocols, such as Frame Relay, and Asynchronous Transfer Mode (ATM). In one example, the telecommunication network 110 uses a network function virtualization infrastructure (NFVI), e.g., host devices or servers that are available as host devices to host virtual machines comprising virtual network functions (VNFs). In other words, at least a portion of the telecommunication network 110 may incorporate software-defined network (SDN) components.

As shown in FIG. 1, telecommunication network 110 may also include one or more servers 112. In one example, each of the server(s) 112 may comprise a computing device or processing system, such as computing system 400 depicted in FIG. 4 and may be configured to provide one or more functions for determining a deviation from an expected condition along a navigation path of an uncrewed vehicle based upon visual information from one or more devices along the navigation path, in accordance with the present disclosure. For example, one or more of the server(s) 112 may be configured to perform one or more steps, functions, or operations in connection with the example method 300 described below. For instance, server(s) 112 may collect, store, and process mobile device position/location information (e.g., in latitude and longitude), and visual information from mobile devices, such as from mobile devices 141-143. In addition, server(s) 112 may collect, store, and process location information and visual information, e.g., from camera units 196-198, server(s) 125, and/or other devices or systems for obtaining visual information, which may be utilized in connection with the example method 300 described herein. In one example, server(s) 112 may also receive and store location information and visual information from UAVs 160 and 170, e.g., via wireless access network(s) 115, telecommunication network 110, etc.

In one example, server(s) 125 may include a weather data server (WDS). In such an example, weather data may be obtained by server(s) 112 from server(s) 125 via a weather service data feed, e.g., a National Weather Service (NWS) extensible markup language (XML) data feed, private or home weather stations, or the like. In another example, the weather data may be obtained by retrieving the weather data from the WDS. It should be noted that in one example, server(s) 112 and/or server(s) 125 may receive and store weather data from multiple parties.

In addition, in one example, server(s) 125 may include a geographic information system (GIS). For instance, server(s) 125 may provide a digital elevation model (DEM), which may comprise a set of raster files or other format files, that records elevations for a set of given points (latitude, longitude). For instance, the digital elevation model may comprise Shuttle Radar Topography Mission (SRTM) data, which may provide measurements of elevation (e.g., relative to mean sea level (MSL)) in 1 arc-second, 30 meter resolution. In one example, the digital elevation model may be maintained by a commercial provider, such as Forsk Atoll, and so forth. Accordingly, in one example, server(s) 112 may obtain and store topology information (e.g., for region 190) from server(s) 125. For instance, server(s) 112 may store a digital elevation model for region 190. In one example, the digital elevation model may comprise a composite of digital elevation models from multiple sources. For instance, the STRM digital elevation model may comprise a primary source, while a more refined secondary digital elevation model may be used to supplement the STRM digital elevation model in certain regions or markets (e.g., in cities, particularly those with varying terrain, etc.) to provide a composite digital elevation model. For ease of illustration, various additional elements of telecommunication network 110 are omitted from FIG. 1.

In one example, one or more wireless access networks 115 may each comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network(s) 115 may each comprise an access network in accordance with any “second generation” (2G), “third generation” (3G), “fourth generation” (4G), Long Term Evolution (LTE), “fifth generation” (5G), or any other existing or yet to be developed future wireless/cellular network technology. While the present disclosure is not limited to any particular type of wireless access network, in the illustrative example, base stations 117 and 118 may each comprise a Node B, evolved Node B (eNodeB), or gNodeB (gNB), or any combination thereof providing a multi-generational/multi-technology-capable base station. In the present example, mobile devices 141-143 and UAVs 160 and 170 may be in communication with base stations 117 and 118, which provide connectivity between UAVs 160 and 170, mobile devices 141-143, and other endpoint devices within the system 100, various network-based devices, such as server(s) 112, server(s) 125, and so forth. In one example, wireless access network(s) 115 may be operated by the same service provider that is operating telecommunication network 110, or one or more other service providers.

As illustrated in FIG. 1, each of the mobile devices 141-143 may comprise, for example, a cellular telephone, a smartphone, a tablet computing device, a laptop computer, a wireless enabled wristwatch, or any other wireless and/or cellular-capable mobile telephony and computing devices (broadly, a “mobile device” or “mobile endpoint device”). In one example, mobile devices 141-143 may be equipped for cellular and non-cellular wireless communication. For instance, mobile devices 141-143 may include components which support peer-to-peer and/or short range wireless communications. Thus, each of the mobile devices 141-143 may include one or more radio frequency (RF) transceivers, e.g., for cellular communications and/or for non-cellular wireless communications, such as for IEEE 802.11 based communications (e.g., Wi-Fi, Wi-Fi Direct), IEEE 802.15 based communications (e.g., Bluetooth, Bluetooth Low Energy (BLE), and/or ZigBee communications), and so forth.

In accordance with the present disclosure, UAV 160 may include at least a camera 162 and one or more radio frequency (RF) transceivers 166 for cellular communications and/or for non-cellular wireless communications. In one example, UAV 160 may also include a module 164 with one or more additional controllable components, such as a microphone, an infrared, ultraviolet or visible spectrum light source, and so forth. It should be noted that UAV 170 may be similarly equipped. However, for ease of illustration, specific labels for such components of UAV 170 may be omitted from FIG. 1.

In addition, in one example, each of the mobile devices 141-143, camera units 196-198, and UAVs 160 and 170 may comprise all or a portion of a computing device or processing system, such as computing system 400 as described in connection with FIG. 4 below, specifically configured to perform various steps, functions, and/or operations in connection with examples of the present disclosure for determining a deviation from an expected condition along a navigation path of an uncrewed vehicle based upon visual information from one or more devices along the navigation path.

For instance, owners and/or users of mobile devices 141-143 and camera units 196-198 may register mobile devices 141-143 and camera units 196-198 (with the owners' consents) for being used in connection with validating expected conditions along a navigation path for an uncrewed vehicle. For instance, camera units 196-198 may each earn a fixed fee, e.g., per week, per month, etc. and/or a per-use/per-transaction in exchange for allowing the use of camera units 196-198 for obtaining visual information to validate expected conditions along a navigation path, as described herein. Similarly, mobile devices 141-143 may each earn a fixed fee and/or per-use fee to similarly provide or allow the obtaining of visual information therefrom in connection with validating expected conditions along a navigation path for an uncrewed vehicle. In one example, UAVs 160 and 170 may similarly be registered for use in connection with validating expected conditions along a navigation path for an uncrewed vehicle. For instance, each UAV may be registered to provide visual information for validating one or more expected conditions for a navigation path of a different UAV.

In an illustrative example, a processing system for determining a deviation from an expected condition along a navigation path of an uncrewed vehicle based upon visual information from one or more devices along the navigation path may comprise one or more of server(s) 112. Accordingly, in such an example, mobile devices 141-143 and cameras 196-198 may be registered with server(s) 112. In one example, camera units 196-198 may be remotely controllable, e.g., by server(s) 112 for automatically obtaining visual information in connection with the present examples. For instance, visual information may be obtained by server(s) 112 from camera units 196-198, e.g., without further approval on a per-transaction basis from one or more owners and/or operators of camera units 196-198. However, in one example, each time an accessing of visual information by server(s) 112 from camera units 196-198 is desired, server(s) 112 may seek and obtain prior approval from such owner(s) and/or operator(s) via communication devices of such owner(s) and/or operator(s) (not shown). In various examples, approval may be obtained from an automated system and/or a human agent, e.g., depending upon the capabilities and/or preferences of the camera units 196-198 and the owner(s) and/or operator(s) thereof. Similarly, server(s) 112 may seek and obtain prior approval from owners and/or user of mobile devices 141-143, UAVs 160 and/or 170, etc., each time an accessing of visual information by server(s) 112 is desired from mobile devices 141-143, UAVs 160 and/or 170, and so forth.

In one example, server(s) 112 may comprise an uncrewed vehicle monitoring service. In one example, the service may be provided by a governmental entity that is tasked with regulating and monitoring UAV operations. In another example, the service may be provided by a public-private partnership, or quasi-governmental agency, or a non-governmental entity that is delegated responsibility to fulfill administrative regulatory duties. For instance, the server(s) 112 may receive proposed flight paths and/or flight plans for UAV, and may review and approve, or deny, such flight paths. Alternatively, or in addition, the server(s) 112 may obtain desired destination information for UAVs (and current location information), and may calculate, select, and provide flight paths (and/or flight plans) to such UAVs, and/or to operators thereof. For instance, server(s) 112 may coordinate among different proposed or candidate flight paths, and flight plans, for different UAVs which may be seeking to navigate within the region 190, e.g., at the same time. Thus, server(s) 112 may obtain information regarding the intended navigation paths of UAVs, the current locations of UAVs, as well as conditions along such paths (and/or conditions within the region 190 in general, insofar as various UAVs may seek to operate generally anywhere within such region 190). Server(s) 112 may then continually monitor for conflicts, denying proposed navigation paths where possible conflicts are detected, selecting from among possible navigation paths to avoid conflicts, and so forth. In one example, server(s) 112 may also detect deviations from expected conditions along a UAVs navigation path and may take one or several remedial actions. For instance, remedial actions may depend upon the nature of the deviation.

To illustrate, UAV 160 may be commencing a flight. In one example, the UAV 160 may be controlled by an operator via remote control device 169. In another example, the UAV 160 may be a self-operating vehicle, or “drone.” In one example, the UAV 160 or an operator, via remote control device 169, may provide a navigation path 180 (e.g., an anticipated or expected navigation path) to server(s) 112. Alternatively, or in addition, the UAV 160 or the operator, via remote control device 169, may provide a desired destination (and in one example, a current location of UAV 160) to server(s) 112. Server(s) 112 may then calculate the navigation path 180, and provide the navigation path 180 to UAV 160 and/or remote control device 169. In one example, the navigation path 180 comprises a set of expected positions and times. For instance, the navigation path may include position P1 at a time T1. In other words, the UAV 160 is expected to be at or near position P1 on or around time T1 in accordance with the navigation path 180. Similarly, UAV 160 may be expected to be at or near position P2 on or around time T2, and likewise for position P3-time T3 and position P4-time T4.

It should be noted that the positions P1-P4 and times T1-T4 may be approximate so as to allow some latitude in the fight path, the speed of the flight, traffic congestion, the current weather conditions such as wind and etc. For instance, server(s) 112 may provide approval for the navigation path 180, within a certain time limit, or time limits of validity. For instance, the UAV 160 may be cleared and permitted to fly over position P2 during a two minute time interval, a four minute time interval, etc. after which, other aerial vehicles may be expected and/or permitted to be in substantially the same space (e.g., at or near position P2, within a distance that would be deemed unsafe if UAV 160 were at position P2 at such time).

In accordance with the present disclosure, server(s) 112 may determine expected conditions along the navigation path 180. For instance, the set of positions-time pairs may be considered expected conditions along the navigation path 180. In addition, expected conditions may include weather conditions and the presence and/or state of possible obstructions along the navigation path 180. In one example, the weather conditions may include a visibility level, a condition of snow, rain, hail, and/or sleet (or a lack thereof), a wind speed or wind speed level (e.g., force 3, force 5, etc.), and so forth. As noted above, the weather conditions may be obtained from a weather data service (WDS) (e.g., represented by one or more of server(s) 125). For instance, the WDS may provide weather forecasts relating to one or more types of weather conditions for locations (or positions in three-dimensional space) of region 190.

In one example, possible obstructions within region 190 may be determined in accordance with topographical information maintained by server(s) 112. For instance, as noted above server(s) 112 may obtain a digital elevation model (DEM) for region 190. Thus, varying terrain may be identified from the DEM. For instance, server(s) 112 may determine that navigation path 180 should include a flight level above 500 meters (at least in part) due to mountainous terrain (along at least part of the navigation path 180) that exceeds 450 meters. In other words, at least a 50 meter buffer over such obstruction may be included in the navigation path 180.

In addition, in accordance with the present disclosure server(s) 112 may maintain additional obstruction information, e.g., as part of the digital elevation model and/or in a separate data storage component that is linked to the digital elevation model. For example, server(s) 112 may build and maintain an information database regarding non-topological obstructions, which may include buildings, towers (e.g., radio broadcast towers, cellular base station towers, towers for roller-coasters or other amusement park rides, airport control towers, etc.), and so forth. Thus, non-topological obstructions that may be expected along expected navigation path 180 may also be identified by server(s) 112. In one example, the server(s) 112 may alter navigation path 180, e.g., where navigation path 180 is submitted to server(s) 112 for approval and an obstruction is identified on the navigation path 180 (e.g., within a distance range of a center line of the navigation path 180 such that the obstruction may be considered a non-zero risk). In one example, server(s) 112 may approve the navigation path 180, but may provide a notification to the UAV 160 and/or an operator thereof (e.g., at remote control device 169) of the obstruction, e.g., including information regarding the characteristics thereof and the location, or position of the obstruction).

In one example, the information database of obstructions may comprise information that is obtained fully or partially from another party. For instance, one or more of server(s) 125 may represent resources of a service for maintaining and providing obstruction information. Thus, for instance, server(s) 112 may in one example subscribe to such a service and obtain such information from the one or more of server(s) 125. For example, in accordance with such a service, UAVs may be tasked with supplementing GIS topology information with more specific measurements of smaller areas within region 190. For instance, UAVs may capture location and visual information to help build object models, and to place such models at locations/positions within the digital elevation model for region 190. For example, UAVs (such as UAVs 160 and 170) may be used to capture measurements of physical properties of towers, buildings, and so on.

Server(s) 125 may receive and process these measurements to learn an object model. In one example, object models may be learned from the captured data via a generative adversarial network (GAN) learning process. For instance, server(s) 125 may learn a generator function and a discriminator (e.g., an object mode) for each object (such as a building, a tower, etc.) that is being modeled. In one example, server(s) 125 may provide instructions to UAVs to capture additional measurements of physical properties of an object by repositioning, reorienting cameras, and so on. In one example, the learning of object models and the placement of such models at appropriate geographic locations (e.g., within a digital elevation model, or the like) may have human involvement and direction in terms of selecting locations or areas to be surveyed, providing UAVs for such surveying, maintaining such UAVs, and so forth. Alternatively, or in addition, UAV services for such surveying may be crowd-sourced by soliciting assistance from individual UAV owners and/or operators who may be willing to provide the use of their equipment for the purpose of such surveying.

In any case, server(s) 112 may obtain obstruction information from server(s) 125, and store such obstruction information for subsequent retrieval and use in connection with verifying navigation paths for UAVs, as described herein. Alternatively, or in addition, server(s) 112 may build and maintain object model, e.g., in the same or substantially similar manner as described above in connection with server(s) 125. For instance, an operator of telecommunication network 110 may build and maintain a database of obstruction information, e.g., in addition to voice, television, and data communication services.

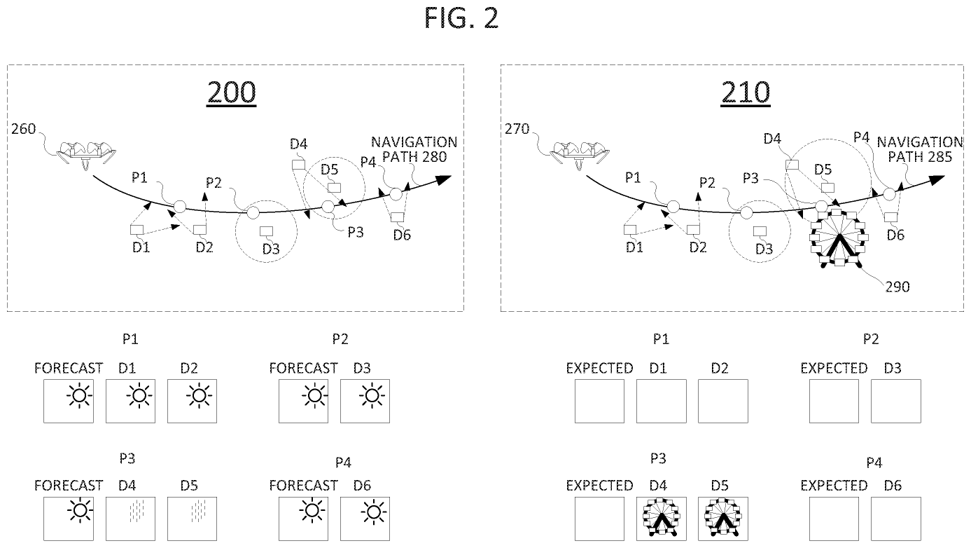

In addition to the foregoing, examples of the present disclosure utilize visual information from one or more cameras of one or more devices along the navigation path 180 in order to determine deviations from expected conditions along the navigation path 180. For instance, as noted above, the expected conditions may comprise expected positions (e.g., positon-time pairs P1-T1, P2-T2, P3-T3, P4-T4, etc.), expected weather conditions, and expected obstruction conditions. For illustrative purposes, FIG. 1 includes an example of detecting a deviation of UAV 160 from an expected position along the navigation path 180. Other examples of detecting a deviation from an expected weather condition, and detecting a deviation from an expected condition of an obstruction are illustrated in FIG. 2.

In one example, after determining a navigation path (e.g., navigation path 180), server(s) 112 may then identify devices along the navigation path 180 which may be available to provide visual information from one or more cameras. It should be noted that the locations of camera units 196-198 may be known, fixed locations, e.g., cameras placed on traffic lights or light poles, other government owned assets (e.g., cameras deployed at state government buildings, local government buildings, police stations, etc.) or privately owned assets such as traffic cameras or home security cameras (e.g., doorbell cameras and floodlight cameras, etc.). As such, server(s) 112 may determine that camera units 196-198 are geographically suitable for use in verifying the expected condition(s) along navigation path 180. For instance, server(s) 112 may identify and select devices within a threshold distance from a center-line of the navigation path 180 as candidates for use in verifying the expected condition(s) along navigation path 180. Similarly, server(s) 112 may identify and select mobile devices 141-143 (e.g., insofar as such devices may be within the threshold distance from the center line of navigation path 180). The locations of mobile devices 141-143 may be obtained from network information of telecommunication network 110 (in accordance with permissions of owners or users of mobile devices 141-143 to use such location information in connection with an uncrewed vehicle monitoring service).

As noted above, in one example, server(s) 112 may automatically access the visual information from some or all of camera units 196-198 and mobile devices 141-143, and/or may communicate with any one or more of the camera units 196-198, mobile devices 141-143, and/or owner(s) or operator(s) thereof to obtain approval to access the respective visual information. In one example, the accessing of camera units 196-198 and mobile devices 141-143 may also include transmitting instructions to the one or more devices along the navigation path 180 to provide the visual information from the one or more cameras. For instance, the camera units 196-198 may not be “always-on” devices but may be activated for specific uses as desired. In one example, server(s) 112 may provide camera orientation instructions to camera units 196-198 to cause respective cameras to have the preferred orientations. For instance, camera units 196-198 may be automatically reoriented in accordance with such instructions. It should be noted that in some cases camera units 196-198 may comprise panoramic and/or 360 degree cameras, which may not require any reorientation in order to capture visual information of navigation path 180.

In one example, server(s) 112 may communicate similar instructions to mobile devices 141-143 regarding camera orientations. However, the instructions may be provided in, or at least presented at mobile devices 141-143 in human-interpretable form to allow a user to understand where to orient a respective camera. In one example, each of mobile devices 141-143 may include a respective application which may assist a user in achieving the correct orientation. Accordingly, camera units 196-198 and mobile devices 141-143 may capture and provide visual information of navigation path 180 to server(s) 112. In various examples, the visual information may comprise still images, series of still images, videos, stitched panoramas, 360 camera still images and/or 360 video, and so forth, e.g., depending upon the configuration of server(s) 112, the capabilities of camera units 196-198 and mobile devices 141-143, the available bandwidth or other resources of wireless access network(s) 115, and so forth. In this regard, it should be noted that in one example, components of wireless access network(s) 115 and telecommunication network 110 may also be configured to route/forward visual information from mobile devices 141-143 (and other mobile devices) to server(s) 112. For instance, components of wireless access network(s) 115 and/or telecommunication network 110 may be configured as a DMaaP (data movement as a platform) system, may be configured in a Kafka streaming architecture, and so forth.

It should also be noted that in one example, server(s) 112 may communicate with and may obtain visual information directly from camera units 196-198. However, in another example, server(s) 112 may obtain visual information, and may seek and obtain approval for the use of camera units 196-198 from one or more of server(s) 125. For instance, server(s) 125 may manage camera units 196-198, or may obtain and stream visual feeds of camera units 196-198. For instance, in an illustrative example, camera units 196-198 may generally be used for crop monitoring and may provide a remote visual feed that is generally consumed by an agribusiness at desktop or mobile devices of personnel of such a business. However, in accordance with the present disclosure, these visual feeds may alternatively or additionally be redirected or copied to server(s) 112. In addition, server(s) 112 may request reorientation of cameras of camera units 196-198, which may be received by server(s) 125 and subsequently carried-out via communications between server(s) 125 and camera units 196-198, on behalf of server(s) 112.

In accordance with the present disclosure, after gathering the visual information from camera units 196-198 and mobile devices 141-143, server(s) 112 may process the visual information to detect deviations from one or more expected conditions of navigation path 180. In the example illustrated in FIG. 1, the deviation from the expected condition may be that the UAV 160 is not at or near position P3 on or around time T3 (and similarly not at or near position P4 on or around time T4). The reality may be that UAV 160 is at position P5 at time T3 and at position P6 at time T4. Thus, for example the actual path of UAV 160 is indicated as deviation 185 in FIG. 1. It should be noted that UAV 160 may continue to wirelessly transmit location information (e.g., to server(s) 112 via base stations 117 and/or 118, wireless access network(s) 115, telecommunication network 110, etc.), purporting to comprise successive current locations of UAV 160. For instance, UAV 160 may assert that it is at position P3 at time T3 and location P4 at time T4. However, in accordance with the present disclosure, UAV self-reported location information may be untrusted insofar as a UAV (such as UAV 160) may be subject to an attack which may attempt to cause UAV 160 to navigate off course, UAV 160 may be subject to an attack which may gain control of UAV 160 by an unauthorized entity which may seek to navigate UAV 160 somewhere else, UAV 160 may be subject to a jamming attack which causes a legitimate remote operator (e.g., at remote control device 169) to lose control of UAV 160, UAV 160 may have malfunctioning software or hardware components which cause UAV 160 to falsely measure its own position and/or to falsely (but unintentionally) report such position, and so forth. Continuing with the present example, UAV 160 may assert that it is at position P3 at time T3, while in reality, UAV 160 is at position P5 at time T3.

The deviation 185 may be detected via visual information from one or more of camera units 196-198 and mobile devices 141-143. For instance, camera unit 198 and mobile devices 141 and 142 may all provide visual information that includes location P3. Server(s) 112 may process at least this portion of the visual information to determine that UAV 160 is not detected within at least the portion of the visual information. To illustrate, in order to detect the UAV 160 in visual information, server(s) 112 may store visual information of UAV 160 (and may similarly store visual information for other UAVs) as a detection model (or detection models) for the UAV 160. This may include one or more images of UAV 160 (e.g., from different angles), and may alternatively or additionally include a feature set derived from one or more images of UAV 160. For instance, for UAV 160, server(s) 112 may store a respective scale-invariant feature transform (SIFT) model, or a similar reduced feature set derived from image(s) of UAV 160, which may be used for detecting UAV 160 in the visual information from camera units 196-198 and mobile devices 141-143 via feature matching. Thus, in one example, a feature matching detection algorithm employed by server(s) 112 may be based upon SIFT features. However, in other examples, different feature matching detection algorithms may be used, such as a Speeded Up Robust Features (SURF)-based algorithm, a cosine-matrix distance-based detector, a Laplacian-based detector, a Hessian matrix-based detector, a fast Hessian detector, etc.

The visual features used for detection and recognition of UAV 160 (and other UAVs) may include low-level invariant image data, such as colors (e.g., RGB (red-green-blue) or CYM (cyan-yellow-magenta) raw data (luminance values) from a CCD/photo-sensor array), shapes, color moments, color histograms, edge distribution histograms, etc. Visual features may also relate to movement in a video and may include changes within images and between images in a sequence (e.g., video frames or a sequence of still image shots), such as color histogram differences or a change in color distribution, edge change ratios, standard deviation of pixel intensities, contrast, average brightness, and the like. Visual features may also relate to serial or registration numbers, banners, logos, and the like. For instance, these features may be used to distinguish between a UAV in flight and other things, such as flying birds, ground-based vehicles moving on a road, etc.

In one example, the server(s) 112 may perform an image salience detection process, e.g., applying an image salience model and then performing an image recognition algorithm over the “salient” portion of the image(s) or other visual information from camera units 196-198 and mobile devices 141-143. Thus, in one example, visual features may also include a length to width ratio of an object, a velocity of an object estimated from a sequence of images (e.g., video frames), and so forth. Similarly, in one example, server(s) 112 may apply an object detection and/or edge detection algorithm to identify possible unique items in the visual information from camera units 196-198 and mobile devices 141-143 (e.g., without particular knowledge of the type of item; for instance, the object/edge detection may identify an object in the shape of a UAV in a video frame, without understanding that the object/item is a UAV). In this case, visual features may also include the object/item shape, dimensions, and so forth. In such an example, object recognition may then proceed as described above (e.g., with respect to the “salient” portions of the image(s) and/or video(s)).

In one example, the detection of UAV 160 in the visual information from camera units 196-198 and mobile devices 141-143 may be performed in accordance with one or more machine learning algorithms (MLAs), e.g., one or more trained machine learning models (MLMs). For instance, a machine learning algorithm (MLA), or machine learning model (MLM) trained via a MLA may be for detecting a single item, or may be for detecting a single item from a plurality of possible items that may be detected via the MLA/MLM. For instance, the MLA (or the trained MLM) may comprise a deep learning neural network, or deep neural network (DNN), a generative adversarial network (GAN), a support vector machine (SVM), e.g., a binary, non-binary, or multi-class classifier, a linear or non-linear classifier, and so forth. In one example, the MLA/MLM may be a SIFT or SURF features-based detection model, as mentioned above. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on. In one example, the item detection MLM(s) may be trained at a network-based processing system (e.g., server(s) 112, server(s) 125, or the like).

Server(s) 112 may thus apply the above or similar object detection and/or recognition processes to attempt to identify UAV 160 in the visual information from camera units 196-198 and mobile devices 141-143. However, since in the illustrative example of FIG. 1, UAV 160 engages in deviation 185, server(s) 112 may obtain the visual information from camera unit 198 and mobile devices 141 and 142 near position P3 and determine that UAV 160 is not detected within any of this portion of the visual information. Accordingly, server(s) 112 may determine that a deviation from an expected condition along navigation path 180 has occurred, e.g., that UAV 160 is not in the expected position P3 at the expected time T3. For instance, the UAV 160 may have deviated off course from the navigation path 180, indicated in FIG. 1 as “deviation 185.”

It should be noted that server(s) 112 may also apply the above or similar object detection and/or recognition processes to attempt to identify UAV 160 in the visual information from camera units 198 and mobile device 141 with respect to position P4 at time T4. For instance, instructions from server(s) 112 may additionally instruct camera units 198 and mobile device 141 to orient cameras toward position P4 at or around time T4 and to capture and provide visual information thereof to server(s) 112. Server(s) 112 may then also determine that UAV 160 is not detected in this portion of the visual information. Thus, the deviation (e.g., deviation 185) from the expected condition along navigation path 180 may be further confirmed.

It should be noted that in one example, server(s) 112 may not actually be aware of the correct position(s) of UAV 160 at times T3 and T4 (e.g., at positions P5 and P6, respectively). However, in another example, server(s) 112 may also obtain visual information of other devices (e.g., other camera units or mobile devices) nearby the navigation path 180. Alternatively, or in addition, upon detecting a deviation from an expected position along navigation path 180, server(s) 112 may engage camera units 196-198 and mobile devices 141-143 to reorient cameras, such as to perform a 360 degree scan in both azimuth and elevation, to attempt to locate UAV 160. For example, camera unit 196 may be within sight range of position P3, and may perform a sweep/scan that captures position P3. Thus, visual information from camera unit 196 may be provided to server(s) 112. In turn, server(s) 112 may process the visual information from the sweep by camera unit 196 and may detect UAV 160 in the visual information.

Regardless of whether server(s) 112 may have an actual position for UAV 160, server(s) 112 may engage in one or more remedial actions to address the detection of the deviation. For instance, server(s) 112 may transmit a notification of the deviation 185 to one or more parties, such as the UAV 160, an operator at remote control device 169 (or an automated remote control system for UAV 160), and so forth. For instance, UAV 160, or a remote operator thereof, may be unaware that UAV 160 is operating with faulty GPS sensors and has deviated from the navigation path 180. A notification of the deviation 185 may therefore allow UAV 160 and/or the remote control device 169 to enter a safety protocol, such as returning to a starting location, finding a nearest safe landing zone, slowing down and/or reducing a maximum permitted speed, engaging an enhanced sensing mode to better detect possible nearby obstacles, or contacting other UAVs in the immediate vicinity for location information, and so forth. In one example, the notification may be sent to a processing system of a public safety entity (e.g., a local municipality, a local police department, a private security company specifically tasked with providing this monitoring and controlling service, and the like). For instance, the public safety entity may be permitted to and tasked with taking control of UAVs that may be reporting false locations or which are otherwise off course. For example, as part of a UAV certification, manufacturers may include remote override modules to permit such a public safety entity to take control of UAVs. Alternatively, or in addition, human operators may be required to provide a mechanism for such a public safety entity to access a UAV in order to obtain a license or to be permitted to operate a UAV in region 190. In another example, server(s) 112 may also fulfill such a role. In other words, server(s) 112 may comprise the public safety entity, and may remotely take control of UAV 160.

The foregoing illustrates just one example of determining a deviation from an expected condition along a navigation path of an uncrewed vehicle based upon visual information from one or more devices along the navigation path, in accordance with the present disclosure. Additional examples are illustrated in FIG. 2 and described in greater detail below.

It should also be noted that the system 100 has been simplified. In other words, the system 100 may be implemented in a different form than that illustrated in FIG. 1. For example, the system 100 may be expanded to include additional networks, and additional network elements (not shown) such as wireless transceivers and/or base stations, border elements, routers, switches, policy servers, security devices, gateways, a network operations center (NOC), a content distribution network (CDN) and the like, without altering the scope of the present disclosure. In addition, system 100 may be altered to omit various elements, substitute elements for devices that perform the same or similar functions and/or combine elements that are illustrated as separate devices.

As just one example, one or more operations described above with respect to server(s) 112 may alternatively or additionally be performed by server(s) 125, and vice versa. In addition, although server(s) 112 and 125 are illustrated in the example of FIG. 1, in other, further, and different examples, the same or similar functions may be distributed among multiple other devices and/or systems within the telecommunication network 110, wireless access network(s) 115, and/or the system 100 in general that may collectively provide various services in connection with examples of the present disclosure for determining a deviation from an expected condition along a navigation path of an uncrewed vehicle based upon visual information from one or more devices along the navigation path.

Additionally, devices that are illustrated and/or described as using one form of communication (such as a cellular or non-cellular wireless communications, wired communications, etc.) may alternatively or additionally utilize one or more other forms of communication. For instance, camera units 196-198 may alternatively or additionally be equipped for cellular communications, wireless wide-area network (WWAN) communications, and so forth. In such examples, camera units 196-198 may communicate with other devices or systems, such as server(s) 125 and/or server(s) 112, via base stations 117 and/or 118, wireless access network(s) 115, and so forth. Thus, these and other modifications are all contemplated within the scope of the present disclosure.

FIG. 2 illustrates additional examples of determining a deviation from an expected condition along a navigation path of an uncrewed vehicle based upon visual information from one or more devices along the navigation path, in accordance with the present disclosure. For instance, in an additional scenario 200, UAV 260 may be cleared to navigate along navigation path 280, which may comprise points P1-P4, as illustrated. In one example, a processing system of the present disclosure (such as server(s) 112 and/or server(s) 125 of FIG. 1, or the like) may identify and obtain the use and/or cooperation of devices 1-6 (D1-D6) along the navigation path 280. For instance, devices D1-D6 may each be camera-equipped and configured for wired and/or wireless communications, and may each comprise one of a mobile device, a camera unit, another UAV or other uncrewed vehicles, and so forth. For ease of illustration, the processing system, communication links (including networks and components thereof supporting communications), and so forth, are omitted from FIG. 2. However, it should be understood that such items may be present and may be utilized to perform or support operations in connection with the example scenarios 200 and 210 of FIG. 2. For instance, in one example, all or a portion of the system 100 may be utilized in connection with the example scenarios 200 and 210 of FIG. 2.

In scenario 200, the processing system may determine expected weather conditions (e.g., forecast weather) for positions P1-P4 in anticipation of UAV 260 navigating along navigation path 280 (or in anticipation of UAV 260 reaching positions P1-P4 successively, as the UAV 260 is already proceeding along the navigation path 260). For instance, the forecast weather for positions P1-P4 may be as illustrated in the boxes below the navigation path 280. In one example, the forecast weather (or expected weather conditions) may be obtained from a weather data server, e.g., as described above. In the present example, the forecast may be for clear and/or sunny weather for all of positions P1-P4 along the navigation path 280. The processing system may then obtain visual information from devices D1-D6 which have been identified along the navigation path 280 and which have been confirmed to provide such visual information for the navigation path 280. The fields of view, or camera orientations of devices D1-D6 are shown in the illustrated example. In particular, devices D1 and D2 may have cameras oriented to include position P1 with the respective fields-of-view. Notably, devices D3 and D5 may comprise 360 degree cameras, and may include positions P2 and P3 within respective fields-of-view. Device D4 may have a camera oriented toward position P3, while device D6 may have a camera oriented toward position P4. The contents of the visual information from devices D1-D6 may be as illustrated in the boxes below the navigation path 280. For instance, the visual information from devices D1, D2, D3, and D6 may all indicate clear and/or sunny weather. However, the visual information from devices D4 and D5 may indicate rain. Since devices D4 and D5 have cameras oriented to include position P3, this visual information may be associated with position P3. In addition, since the visual information indicates weather that is different from the forecast weather for position P3, the processing system may dynamically determine a deviation from the expected weather condition for position P3 would be appropriate.

In one example, the processing system may apply a recognition algorithm to the visual information from devices D4 and D5, which may result in the identification of the weather as being “rainy” or “poor visibility.” For instance, the processing system may apply various detection/recognition models for various weather conditions, which may result in a match for “rainy” (and/or “poor visibility”). In a similar manner, the visual information of devices D1, D2, D3, and D6 may be identified to include the weather “sunny” or “clear.” For instance, the processing system may possess and may apply visual features-based detection models (such as SURF models, SIFT models, or the like), for various potential weather conditions such as “sunny,” “raining,” “foggy,” “snowing,” “hailing,” etc.

Upon detecting the deviation from the expected weather condition, the processing system may then implement at least one remedial action. For instance, the processing system may transmit a notification of the deviation from the expected weather condition, e.g., to UAV 260, to an remote control device being used to control UAV 260, to a processing system of a public safety entity, e.g., for informational purposes, and/or to take over control of UAV 260, and so forth. Alternatively, or in addition, the processing system may calculate and alternate path which may avoid the position P3 where the deviation from the expected weather condition is encountered. For instance, the processing system may transmit instructions to the UAV 260 and/or an operator thereof at a remote control device to navigate along the alternate path. In addition, in one example, the processing system may remotely take control of UAV 260. For instance, in such case, the processing system may also fulfill the role of such a public safety entity. For example, the processing system may remotely command the UAV 260 in order to avoid position P3 and/or to navigate along the alternative path that is computed. It should also be noted that in such case, once the alternative path is computed, the processing system may perform similar operations as described above to identify additional devices along the alternative path to provide visual information in order to verify expected weather conditions (or other expected conditions) along the alternative path.

Scenario 210 illustrates a UAV 270 that is to navigate along navigation path 285. Navigation path 285 may be a proposed path submitted by UAV 270 and/or an operator thereof for approval. In another example, navigation path 285 may be an approved path that UAV 270 is already navigating along or which UAV 270 is anticipated to commence. Similar to scenario 200, the processing system may identify and confirm the availability and cooperation of devices D1-D6 along navigation path 285 to provide visual information for the navigation path 285 (e.g., visual information containing positions P1-P4 along the navigation path 285). The fields of view, or camera orientations of devices D1-D6 are shown in the illustrated example of scenario 210. In the present example, expected conditions along navigation path 285 may be as illustrated in the boxes below the navigation path 285. For instance, the expected conditions may relate to possible obstructions along the navigation path 285.

As illustrated in FIG. 2, the expected conditions for P1-P4 of navigation path 285 may be “clear,” or “no obstruction.” The expected conditions relating to possible obstructions may be obtained from a geographic information system (GIS), such as digital elevation model (DEM) with elevations. For instance, steep and/or mountainous terrain may be determined to comprise potential obstructions depending upon the flight level of the UAV 270. In addition, in one example, the processing system may also maintain and/or access a database of non-terrain obstructions (e.g., object models) and the locations of such non-terrain obstructions (e.g., within a digital elevation model, or the like). In the present example, it may be the case that the digital elevation model and database of non-terrain obstructions indicates that there are no known obstructions within or near the navigation path 285. However, as also shown in FIG. 2, there may actually be a Ferris wheel 290 (e.g., temporally deployed due to a local event such as a local town fair) within or near the navigation path 285 (e.g., at or near position P3). The existence of the Ferris wheel 290 may be indicated in the visual information from devices D4 and D5, e.g., as illustrated in the boxes below the navigation path 285. In one example, the processing system may apply an image salience detection algorithm to the visual information (e.g., of all of devices D1-D6), which may result in the detection of the Ferris wheel 290 in the visual information from devices D4 and D5. In one example, the processing system may not necessarily determine the nature of the Ferris wheel 290, but rather may simply detect that there appears to be a large object where none was previously known to be. In one example, the processing system may further apply an object recognition algorithm to the visual information from devices D4 and D5, which may result in the identification of the Ferris wheel 290 as being a “Ferris wheel.” For instance, the processing system may apply various detection/recognition models for various objects, which may result in a match for a “Ferris wheel.”

In any case, after detecting that there is an obstruction associated with position P3 (e.g., at or near P3), the processing system may then implement at least one remedial action (which may be the same as or similar to the remedial action(s) describe above in connection with scenario 200). For instance, the processing system may transmit a notification of the deviation from the expected condition, e.g., to UAV 270, to a remote control device being used to control UAV 270, to a processing system of a public safety entity, and so forth. Alternatively, or in addition, the processing system may calculate an alternate path which may avoid the position P3 where the deviation from the expected condition is encountered. For instance, the processing system may transmit instructions to the UAV 270 and/or an operator thereof at a remote control device to navigate along the alternate path. In addition, in one example, the processing system may remotely take control of UAV 270. In one example, once the alternative path is computed, the processing system may perform similar operations as described above to identify additional devices along the alternative path to provide visual information in order verify expected conditions along the alternative path.

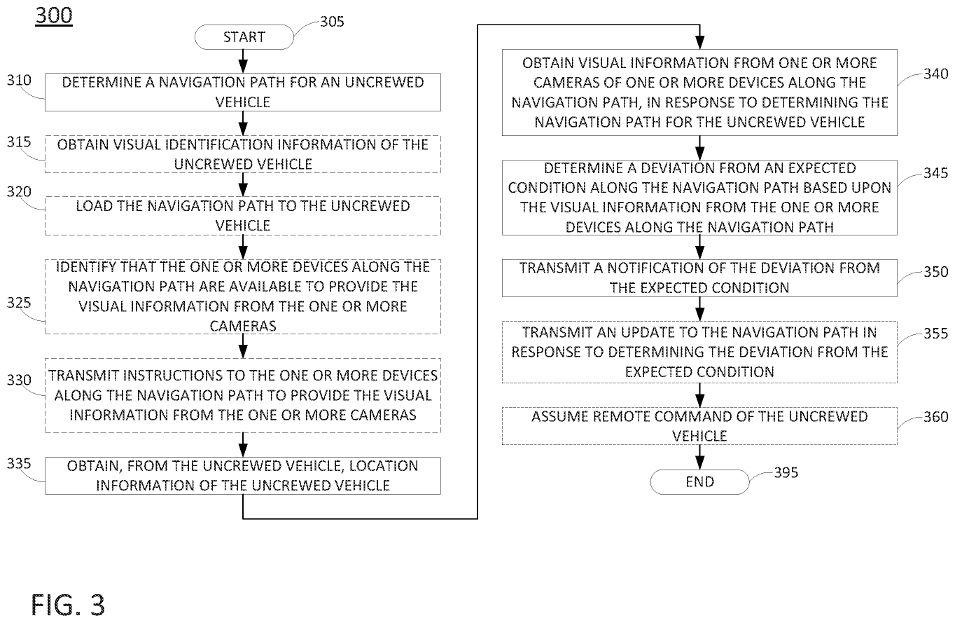

FIG. 3 illustrates a flowchart of an example method 300 for determining a deviation from an expected condition along a navigation path of an uncrewed vehicle based upon visual information from one or more devices along the navigation path. In one example, steps, functions and/or operations of the method 500 may be performed by a device and/or processing system as illustrated in FIG. 1, e.g., by one or more of server(s) 112, or any one or more components thereof, or by server(s) 112 and/or any one or more components thereof in conjunction with one or more other components of the system 100, such as one or more of server(s) 125, elements of wireless access network 115, telecommunication network 110, any one or more of mobile device(s) 141-143 and camera units 196-198, and so forth. In one example, the steps, functions, or operations of method 300 may be performed by a computing device or processing system, such as computing system 400 and/or hardware processor element 402 as described in connection with FIG. 4 below. For instance, the computing system 400 may represent any one or more components of the system 100 that is/are configured to perform the steps, functions and/or operations of the method 300. Similarly, in one example, the steps, functions, or operations of the method 300 may be performed by a processing system comprising one or more computing devices collectively configured to perform various steps, functions, and/or operations of the method 300. For instance, multiple instances of the computing system 400 may collectively function as a processing system. For illustrative purposes, the method 300 is described in greater detail below in connection with an example performed by a processing system. The method 300 begins in step 305 and proceeds to step 310.

At step 310, the processing system determines a navigation path for an uncrewed vehicle. The uncrewed vehicle may comprise, for example: an uncrewed aerial vehicle, an uncrewed underwater vehicle, an uncrewed ground vehicle, or an uncrewed maritime surface vehicle. In accordance with the present disclosure, an uncrewed vehicle may be remotely controlled by a human or an autonomous system, or may be self-operating or partially self-operating (e.g., a combination of on-vehicle and remote computing resources). In one alternate embodiment, such a vehicle in self-operating/autonomous operation mode may still have a human passenger, i.e., not an onboard operator of the vehicle. However, in other embodiments, the uncrewed vehicles are completely devoid of any human passengers.

In one example, step 310 may comprise obtaining the navigation path for the uncrewed vehicle. For instance, the uncrewed vehicle, a remote operator device, or another device associated with an operator (human or non-human) of the uncrewed vehicle may submit a proposed navigation path to the processing system, e.g., for approval and/or tracking. In one example, step 310 may include obtaining a current location of the uncrewed vehicle and a destination of the uncrewed vehicle, and selecting the navigation path for the uncrewed vehicle based upon the current location and the destination. The selection of the navigation path may search for a shortest distance and/or a least time path/fastest path between the current location and the destination, and may account for any locational constraints, such as prohibited travel zones, private properties (e.g., for surface-based vehicles), flight level or depth level restrictions, the interest of other vehicles navigating or seeking to navigate in the same space, an overall level of traffic, forecast weather conditions, the capabilities of the uncrewed vehicle and/or an operator thereof, and so forth. In one example, step 310 may include determining an expected condition along the navigation path, e.g., an expected weather condition at one or more locations along the navigation path (and/or an expected level of visibility), a presence or a position of an object (e.g., an obstruction or a potential obstruction), a tide level (e.g., when the uncrewed vehicle may comprise a submersible vehicle and/or a maritime surface-based vehicle), a type of ground surface (e.g., when the uncrewed vehicle may comprise a ground-operation vehicle), and so forth. It should be noted that visibility, weather conditions, and/or tide levels may comprise forecast measures (e.g., for times when the uncrewed vehicle is anticipated to be at a given location along the navigation path), and may be based upon past observations and current conditions.

In one example, the expected condition(s) may be determined from a weather data server. In one example, the expected condition(s) may alternatively or additionally be determined from various cameras, sensor devices, and so forth within a region that are in communication with and accessible to the processing system. Thus, for example, the navigation path may be initially selected based at least in part upon the expected condition(s) in various parts of the region. For instance, if there is currently fog in one part of the region, the navigation path may be selected that avoids this foggy area. Similarly, where the navigation path is proposed by the uncrewed vehicle (or a remote operator thereof), the processing system may modify the navigation path, or may propose a new/altered navigation path taking into consideration any possible adverse expected conditions to be avoided.

At step 315, the processing system obtains visual identification information of the uncrewed vehicle. For instance, the visual identification information may comprise a respective SIFT model, or a similar reduced feature set derived from image(s) of the uncrewed vehicle, which may be used for detecting the uncrewed vehicle in the visual information from the cameras of the one or more devices via feature matching.

At optional step 320, the processing system may load the navigation plan to the uncrewed vehicle. For instance, in an example where the uncrewed vehicle and/or an operator thereof provides a current location and a destination, the processing system may calculate the navigation path at step 310, and may provide the navigation path at optional step 320.

At optional step 325, the processing system may identify one or more devices along the navigation path that is/are available to provide visual information from one or more cameras. For instance, the devices along navigation path can be fixed cameras, mobile device cameras (e.g., smartphone camera, wearable device cameras, etc.), cameras of other vehicles (e.g., other UAVs and/or autonomous operation vehicles), and so forth. In one example, the one or more devices register to provide the visual information from the one or more cameras in response to requests associated with vehicular navigation. In one example, optional step 325 may include transmitting request(s), and obtaining agreement(s) to provide the visual information (and/or the device(s) sending the visual information in response to the request(s), e.g., thereby also confirming agreement and consent to participate).

At step 330, the processing system may transmit instructions to the one or more devices along the navigation path to provide the visual information from the one or more cameras. In one example, the instructions may include an orientation of at least one of the one or more cameras (and/or may include instructions to obtain a panorama). The visual information may include still images, series of still images, videos, stitched panoramas, 360 camera still images and/or 360 videos, and so forth, depending upon the capability and configuration of the processing system, the capabilities, configurations, and/or permissions of the one or more devices, available uplink bandwidths for the one or more devices, and so forth. In one example, the instructions may be in human interpretable form, or may be transformed into human interpretable form, e.g., where the one or more devices includes at least one mobile device, such as smartphone, a wearable computing device (e.g., smart glasses), or the like.

At step 335, the processing system obtains, from the uncrewed vehicle, location information of the uncrewed vehicle. In one example, the processing system may also obtain visual information of a camera of the uncrewed vehicle. However, as discussed above, this visual information may remain untrusted insofar as the uncrewed vehicle may be controlled by an unauthorized entity that may purposefully transmit false visual information, the uncrewed vehicle may malfunction and transmit old/non-current visual information, and so forth. In addition, the location information may also be untrusted, but may be verified in accordance with additional steps of the present method 300.

At step 340, the processing system obtains visual information from one or more cameras of one or more devices along the navigation path, in response to determining the navigation path for the uncrewed vehicle. For instance, the devices may provide the visual information as requested by transmitting the visual information in the form of still images, video, panoramic images and/or video, 360 degree images and/or video, etc. via one or more networks, such as illustrated in FIG. 1 and described above.

At step 345, the processing system determines a deviation from an expected condition along the navigation path based upon the visual information from the one or more devices along the navigation path. For instance, the deviation from the expected condition may comprise one or more of: a new obstruction, a change in a position or an orientation of an obstruction, a different level of visibility, a different weather condition, a different tide level, a different type of ground surface, and so forth. In one example, the one or more cameras of the one or more devices comprise a plurality of cameras, and the deviation from the expected condition along the navigation path may be determined when the visual information from the one or more cameras comprises a threshold number of indications of the deviation that are determined from the visual information from the plurality of cameras.

In one example, the expected condition comprises an expected position of the uncrewed vehicle along the navigation path. For instance, in one example, the expected position of the uncrewed vehicle along the navigation path may be determined from the location information of the uncrewed vehicle that is obtained at step 335. In such case, the deviation from the expected condition may therefore comprise a deviation from the expected position. For example, the uncrewed vehicle may either not be at an expected position on or around an expected time. For instance, the deviation from the expected position may be determined by identifying that the visual information of the uncrewed vehicle is not detected in a portion of the visual information from the one or more devices along the navigation path that includes the expected position. Alternatively, or in addition, the uncrewed vehicle may be positively detected/identified in visual information for a different position that is off the navigation path at the time the uncrewed vehicle is expected to be at a particular position along the navigation path.

At step 350, the processing system transmits a notification of the deviation from the expected condition. For instance, the notification may be transmitted to one or more of: the uncrewed vehicle, a remote control device of an operator of the uncrewed vehicle, an automated remote control system of the uncrewed vehicle, or a processing system of a public safety entity.

At optional step 355, the processing system may transmit an update to the navigation path in response to determining the deviation from the expected condition (e.g., when the uncrewed vehicle is a vehicle in an autonomous operation mode, although the uncrewed vehicle may have a passenger onboard). For instance, the processing system may provide an alternate path for the uncrewed vehicle to avoid a particular condition that is detected via the visual information from the devices along the navigation path.

At optional step 360, the processing system may assume remote command of the uncrewed vehicle. For example, the processing system may also fulfill the role of a public safety entity that is permitted to and tasked with taking control of uncrewed vehicles that may be reporting false locations or which are otherwise off course, or which may be in distress and which may require or seek assistance from the public safety entity. For example, the processing system may remotely command the uncrewed vehicle in order to avoid a position where a deviation from an expected weather condition, or a deviation from an expected obstruction condition associated with an obstruction is detected, and/or to navigate along an alternative path that is computed.

Following step 350, or any of the optional steps 355-360 the method 300 may proceed to step 395. At step 395, the method 300 ends.

It should be noted that the method 300 may be expanded to include additional steps, or may be modified to replace steps with different steps, to combine steps, to omit steps, to perform steps in a different order, and so forth. For instance, in one example the processing system may repeat one or more steps of the method 300, such as steps 310-350, steps 335-340, steps 335-350, etc. For instance, the processing system may detect a deviation from an expected weather condition and may transmit an alternate navigation path to the uncrewed vehicle. The processing system may then repeat steps 325-340 to monitor for possible deviations from expected condition(s) along the alternative path. In another example, the deviation from the expected condition may also be detected from self-reported camera information from uncrewed vehicle. Similarly, deviations from expected positions may be further determined via detection of a wireless identification signal that may be transmitted by the uncrewed vehicle. For instance, the uncrewed vehicle may report false location data to the processing system in connection with step 335, but may still broadcast a wireless identification signal of the uncrewed vehicle, which may be detectable by devices in the vicinity. However, since the information from the uncrewed vehicle remains untrusted in accordance with the present disclosure, deviations from expected conditions are primarily detected from visual information of crowdsourced devices.

It should also be noted that in one example, the navigation path may include at least one option among a plurality of sub-paths for at least a portion of the navigation path. For instance, the navigation path may include three options for passing around or through a restricted zone from among which the uncrewed vehicle may be permitted to select one of the options at the time the uncrewed vehicle arrives at a branching point along the navigation path. Thus, the processing system may anticipate that the uncrewed vehicle should be along at least one of the three sub-paths after the branching point is reached and/or passed. In this case, the processing system may coordinate to have devices with cameras along all three of the sub-paths ready to provide visual information. Accordingly, if the uncrewed vehicle is confirmed to be along one of the sub-paths via the location information from the uncrewed vehicle and from the visual information provided from the device(s) along the sub-path, no deviation from an expected position will be detected. Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 4 depicts a high-level block diagram of a computing system 400 (e.g., a computing device or processing system) specifically programmed to perform the functions described herein. For example, any one or more components, devices, and/or systems illustrated in FIG. 1 or FIG. 2, or described in connection with FIGS. 1-3, may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where the hardware processor element 402 may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for determining a deviation from an expected condition along a navigation path of an uncrewed vehicle based upon visual information from one or more devices along the navigation path, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 402 is shown, the computing system 400 may employ a plurality of hardware processor elements. Furthermore, although only one computing device is shown in FIG. 4, if the method(s) as discussed above is implemented in a distributed or parallel manner for a particular illustrative example, e.g., the steps of the above method(s) or the entire method(s) are implemented across multiple or parallel computing devices, then the computing system 400 of FIG. 4 may represent each of those multiple or parallel computing devices. Furthermore, one or more hardware processor elements (e.g., hardware processor element 402) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 405 for determining a deviation from an expected condition along a navigation path of an uncrewed vehicle based upon visual information from one or more devices along the navigation path (e.g., a software program comprising computer-executable instructions) can be loaded into memory 404 and executed by hardware processor element 402 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 402) executing the computer-readable instructions relating to the above described method(s) can be perceived as a programmed processor or a specialized processor. As such, the present module 405 for determining a deviation from an expected condition along a navigation path of an uncrewed vehicle based upon visual information from one or more devices along the navigation path (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
determining, by a processing system including at least one processor, a navigation path for an uncrewed vehicle;
obtaining, by the processing system, from the uncrewed vehicle, location information of the uncrewed vehicle;
obtaining, by the processing system, visual information from one or more cameras of one or more devices along the navigation path, in response to determining the navigation path for the uncrewed vehicle;
determining, by the processing system, a deviation from an expected condition along the navigation path based upon the visual information from the one or more devices along the navigation path; and
transmitting, by the processing system, a notification of the deviation from the expected condition.

2. The method of claim 1, wherein the notification is transmitted to one of:
the uncrewed vehicle;
a remote control device of an operator of the uncrewed vehicle;
an automated remote control system of the uncrewed vehicle; or
a processing system of a public safety entity.

3. The method of claim 1, further comprising:
transmitting an update to the navigation path in response to determining the deviation from the expected condition.

4. The method of claim 1, further comprising:
loading the navigation path to the uncrewed vehicle.

5. The method of claim 1, further comprising:
identifying that the one or more devices along the navigation path are available to provide the visual information from the one or more cameras; and
transmitting instructions to the one or more devices along the navigation path to provide the visual information from the one or more cameras.

6. The method of claim 5, wherein the one or more devices have registered to provide the visual information from the one or more cameras in response to a request associated with vehicular navigation.

7. The method of claim 6, wherein the instructions include:
an orientation of at least one of the one or more cameras.

8. The method of claim 1, wherein the determining the navigation path for the uncrewed vehicle comprises:
obtaining the navigation path for the uncrewed vehicle.

9. The method of claim 1, wherein the determining the navigation path for the uncrewed vehicle comprises:
obtaining a current location of the uncrewed vehicle and a destination of the uncrewed vehicle; and
selecting the navigation path for the uncrewed vehicle based upon the current location and the destination.

10. The method of claim 1, wherein the determining the navigation path for the uncrewed vehicle includes:
determining the expected condition along the navigation path.

11. The method of claim 10, wherein the expected condition is determined from at least one of:
a geographic information system; or
a weather data server.

12. The method of claim 1, wherein the expected condition comprises:
a presence or an absence of an obstruction;
a position of an object;
a level of visibility;
a weather condition;
a tide level; or
a type of ground surface.

13. The method of claim 12, wherein the deviation from the expected condition comprises:
a new obstruction;
a change in a position or an orientation of an obstruction;
a different level of visibility;
a different weather condition;
a different tide level; or
a different type of ground surface.

14. The method of claim 1, wherein the expected condition comprises an expected position of the uncrewed vehicle along the navigation path.

15. The method of claim 14, wherein the expected position of the uncrewed vehicle along the navigation path is determined from the location information of the uncrewed vehicle.

16. The method of claim 14, wherein the deviation from the expected condition comprises a deviation from the expected position.

17. The method of claim 16, wherein the visual information from the one or more devices along the navigation path indicates at least one of:
that the uncrewed vehicle is not in the expected position; or
that the uncrewed vehicle is in a different position that is not the expected position.

18. The method of claim 1, further comprising:
obtaining visual identification information of the uncrewed vehicle.

19. A non-transitory computer-readable medium storing instructions which, when executed by a processing system including at least one processor, cause the processing system to perform operations, the operations comprising:
determining a navigation path for an uncrewed vehicle;
obtaining, from the uncrewed vehicle, location information of the uncrewed vehicle;
obtaining visual information from one or more cameras of one or more devices along the navigation path, in response to determining the navigation path for the uncrewed vehicle;
determining a deviation from an expected condition along the navigation path based upon the visual information from the one or more devices along the navigation path; and
transmitting a notification of the deviation from the expected condition.

20. A device comprising:
a processing system including at least one processor; and
a computer-readable medium storing instructions which, when executed by the processing system, cause the processing system to perform operations, the operations comprising:
determining a navigation path for an uncrewed vehicle;
obtaining, from the uncrewed vehicle, location information of the uncrewed vehicle;
obtaining visual information from one or more cameras of one or more devices along the navigation path, in response to determining the navigation path for the uncrewed vehicle;
determining a deviation from an expected condition along the navigation path based upon the visual information from the one or more devices along the navigation path; and
transmitting a notification of the deviation from the expected condition.
